(19) United States
(12) Patent Application Publication
(10) Pub. No.: US 2005/0019651 A1
(43) Pub. Date: Jan. 27, 2005

(54) Rechargeable metal air electrochemical cell incorporating collapsible cathode assembly

(76) Inventors: Tsepin Tsai, Chappaqua, NY (US); Aditi Vartk, Lake Mohegan, NY (US)

Correspondence Address: REVEO, INC., 3 WESTCHESTER PLAZA, ELMSFORD, NY, 10523, US

(21) Appl. No.: 10/500,616

(22) PCT Filed: Dec. 31, 2002
(86) PCT No.: PCT/US02/41685

(30) Foreign Application Priority Data
Dec. 31, 2001 (US) 60344546

(51) Int. Cl. H01M 2/36

(52) U.S. Cl. 429/72

(57) ABSTRACT

The rechargeable metal air electrochemical cell generally includes a pair of air cathode portions centrally disposed and attached to each other with a collapsible mechanism. Anodes are disposed in ionic communication with each air cathode portions via a suitable electrolyte. For recharging, a pair of third charging electrodes is provided ionic communication with the anode portions.

### BACKGROUND OF THE INVENTION

1. Field of the Invention

The present invention relates to metal air electrochemical cells. More particularly, the invention relates to rechargeable metal air electrochemical cells and collapsible cathode assemblies for use therewith.

2. Description of the Prior Art

Electrochemical power sources are devices through which electric energy can be produced by means of electrochemical reactions. These devices include metal air electrochemical cells such as zinc air and aluminum air batteries. Such metal electrochemical cells employ an anode comprised of metal that is converted to a metal oxide during discharge. Certain electrochemical cells are, for example, rechargeable, whereby a current may be passed through the anode to reconvert metal oxide into metal for later discharge. Additionally, refuelable metal air electrochemical cells are configured such that the anode material may be replaced for continued discharge. Generally, metal air electrochemical cells include an anode, a cathode, and electrolyte. The anode is generally formed of metal particles immersed in electrolyte. The cathode generally comprises a bi-functional semipermeable membrane and a catalyzed layer for reducing oxygen. The electrolyte is usually a caustic liquid that is ionic conducting but not electrically conducting.

Metal air electrochemical cells have numerous advantages over traditional hydrogen-based fuel cells. In particular, the supply of energy provided from metal air electrochemical cells is virtually inexhaustible because the fuel, such as zinc, is plentiful and can exist either as the metal or its oxide. Further, solar, hydroelectric, or other forms of energy can be used to convert the metal from its oxide product back to the metallic fuel form with very high energy efficiency. Unlike conventional hydrogen based fuel cells that require refilling, the fuel of metal air electrochemical cells is recoverable by electrically recharging. The fuel of the metal air electrochemical cells may be solid state, therefore, it is safe and easy to handle and store. In contrast to hydrogen based fuel cells, which use methane, natural gas, or liquefied natural gas to provide as source of hydrogen, and emit polluting gases, the metal air electrochemical cells results in zero emission. The metal air fuel cell batteries operate at ambient temperature, whereas hydrogen-oxygen fuel cells typically operate at temperatures in the range of 150° C. to 1000° C. Metal air electrochemical cells are capable of delivering higher output voltages (1-4.5 Volts) than conventional fuel cells (<0.8V).

FIG. 1 shows a conventional metal air cell 100, including a pair of cathodes 104, which is formed along the walls. The cell 100 also includes an anode 108 and a third electrode 106, which serves as a charging electrode. The third electrode 106 is disposed in ionic contact with the anode 108, and is electrically isolated from the cathode 104 with a first separator and electrically isolated from the anode 106 with a second separator. The separators may be the same or different. Ionic contact is provided between the electrodes via electrolyte 110 (e.g., liquid electrolyte, gel electrolyte, or a combination thereof).

Oxygen from the air or another source is used as the reactant for the air cathode 104 of the metal air cell 100. When oxygen reaches the reaction sites within the cathode 104, it is converted into hydroxyl ions together with water. At the same time, electrons are released to flow as electricity in the external circuit. The hydroxyl travels through the electrolyte 110 to reach the metal anode 108. When hydroxyl reaches the metal anode (in the case of an anode 108 comprising, for example, zinc), zinc hydroxide is formed on the surface of the zinc. Zinc hydroxide decomposes to zinc oxide and releases water back to the alkaline solution. The reaction is thus completed.

The anode reaction is:
Zn+4OH⁻→Zn(OH)₄²⁻+2e (1)
Zn(OH)₄²⁻→ZnO+H₂O+2OH⁻ (2)

The cathode reaction is:
½O₂+H₂O+2e→2OH⁻ (3)

Thus, the overall cell reaction is:
Zn+½O₂→ZnO (4)

During recharging, consumed anode material (i.e., oxidized metal), which is in ionic contact with the third electrode 106, is converted into fresh anode material (i.e., metal) and oxygen upon application of a power source (e.g. more than 2 volts for metal-air systems) across the third electrode 106 and consumed anode material. During charging the anode is charged through third electrode. The current flows in through third electrode and converts the anode metal oxide to metal releasing the oxygen.

Since the third electrode 106 is present, the cathode 104 may be a mono-functional electrode, e.g., formulated for discharging while the third electrode 106 is formulated for charging. The third electrode 106 may comprise an electrically conducting structure, for example a mesh, porous plate, metal foam, strip, wire, plate, or other suitable structure. In certain embodiments, the third electrode 106 is porous to allow ionic transfer. The third electrode 106 may be formed of various electrically conductive materials including, but not limited to, copper, ferrous metals such as stainless steel, nickel, chromium, titanium, and the like, and combinations and alloys comprising at least one of the foregoing materials. Suitable charging electrodes include porous metal such as nickel foam metal.

This cell construction has several advantages compared to rechargeable electrochemical cells utilizing a bifunctional electrode. The surface area of the cathode, which is desirably maximized to increase oxygen conversion, need not be balanced with detriments associated with mechanical strength. Further, detriments to the mechanical strength and catalytic activity of the cathode 104 during recharging (i.e., due to the continuous voltage therethrough during recharging) are eliminated with the inclusion of the third electrode.

Nonetheless, problems remain with the third electrode configuration described with respect to FIG. 1. For example, during recharging the anode may be reconditioned, but as there is no reconditioning for the cathode, the lifetime of the cathode may be limited. When the cathode is fixed in the cell, it cannot be replaced or reconditioned, thus making overall cell life short.

Furthermore, it is desirable to eliminate the air supply to the cathode when the cell is not functioning or when the cell is recharging. This prevents CO₂ poisoning of the cathode (i.e., carbonation).

In addition, oxygen that is released during recharging at the third electrode may have tendencies to become trapped between the electrodes. This oftentimes results in regions of the anode that are reconditioned at a slower rate, not reconditioned at all, or otherwise not functional during discharging.

There remains a need in the art for an improved rechargeable metal air electrochemical cell, particularly regarding a cathode assembly for an electrochemical cell.

### SUMMARY OF THE INVENTION

The above-discussed and other problems and deficiencies of the prior art are overcome or alleviated by the several methods and apparatus of the present invention, wherein a rechargeable metal air electrochemical cell is provided. The rechargeable metal air electrochemical cell generally includes a pair of air cathode portions centrally disposed and attached to each other with a collapsible mechanism. Anodes are disposed in ionic communication with each air cathode portions via a suitable electrolyte. For recharging, a pair of third charging electrodes is provided in ionic communication with the anode portions.

In one embodiment, the collapsible mechanism allows contraction of the cathode portions to open space between the cathode portions and the anode portions to facilitate removal of oxygen that has accumulated during charging.

In another embodiment, the collapsible mechanism allows contraction of the cathode portions to cut off air supply during charging or during idle periods, thereby preventing carbonation and extending the useful lifetime of the cathode.

In a further embodiment, the collapsible mechanism allows expansion of the cathode portions to open more space for the air channel to supply air or oxygen to the air cathodes during discharging.

In still another embodiment, the cathode portions are removable, replaceable and/or capable of being reconditioned.

In yet another embodiment, the collapsible mechanism allows contraction of the cathode portions to allow the cathode portions to be electrically disconnected from the anode portions during idle or during charging process.

The above discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of a conventional rechargeable metal air electrochemical cell; and

FIGS. 2A and 2B are schematic representations of an embodiment of a metal air electrochemical cell including a third electrode and a collapsible mechanism incorporated in a cathode assembly as detailed herein.

FIGS. 3A and 3B are discharging and recharging circuit diagrams, respectively, used in one embodiment of the present invention;

FIGS. 3C and 3D are discharging and recharging circuit diagrams, respectively, used in another embodiment of the present invention.

FIGS. 4A and 4B are schematic representations of an embodiment of a metal air electrochemical cell including a switching arrangement, a third electrode and a collapsible mechanism incorporated in a cathode assembly as detailed herein.

FIGS. 5A and 5B are schematic representations of another embodiment of a metal air electrochemical cell in charging and discharging modes, including an anode disposed between a cathode an a third electrode further utilizing a collapsible mechanism incorporated in a cathode assembly as detailed herein.

FIGS. 6A and 6B are schematic representations of an embodiment of a metal air electrochemical cell in charging and discharging modes, including a third electrode arranged on either side of the anode further utilizing a collapsible mechanism incorporated in a cathode assembly as detailed herein.

FIGS. 7A and 7B are schematic representations of an embodiment of a metal air electrochemical cell arranged in a wedge form in charging and discharging modes utilizing collapsible mechanism incorporated in a cathode assembly as detailed herein.

FIGS. 8A and 8B are schematic representations of an embodiment of a metal air electrochemical cell arranged in a wedge form in charging and discharging modes, including a cathode with third electrode affixed thereto, further utilizing a collapsible mechanism incorporated in a cathode assembly as detailed herein.

FIGS. 9A and 9B are schematic representations of an embodiment of a metal air electrochemical cell arranged in a wedge form in charging and discharging modes, including a anode with third electrode affixed thereto, further utilizing a collapsible mechanism incorporated in a cathode assembly as detailed herein.

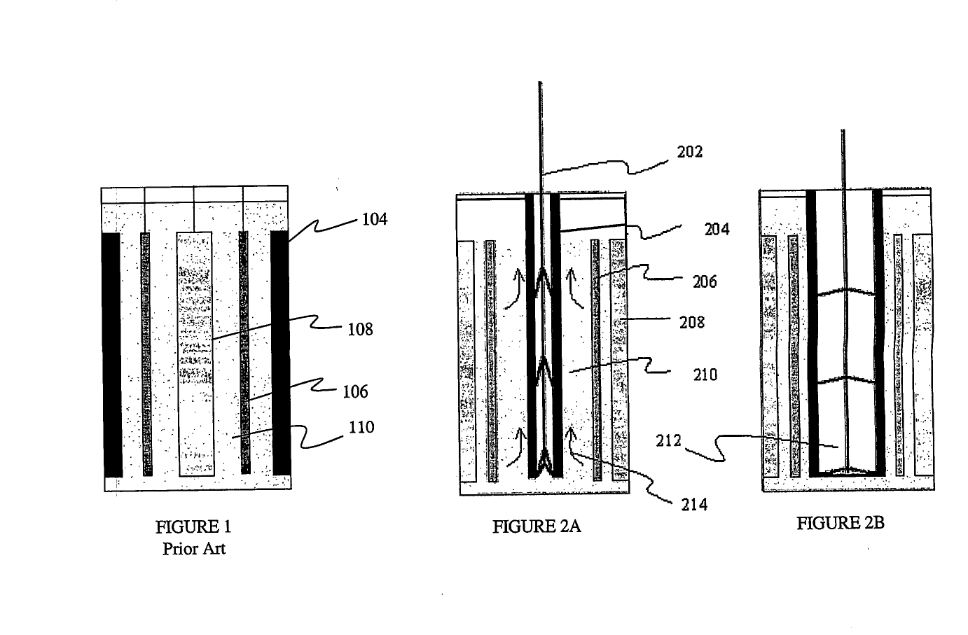

### DETAILED DESCRIPTION OF THE ILLUSTRATIVE EMBODIMENTS

A rechargeable metal air electrochemical cell is provided. The rechargeable metal air electrochemical cell includes a metal fuel anode, and air cathode, a third electrode, and a separator in ionic communication with at least a portion of a major surface of the anode. Furthermore, a structure is provided that facilitates refueling of the anode.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

Referring now to FIGS. 2A and 2B, a rechargeable metal air electrochemical cell 200 is schematically depicted. A pair of anodes 208 are disposed along the inside cell structure walls. Further, a pair of cathodes or cathode portions 204 are disposed centrally in the cell structure, generally in ionic communication with the anodes 208 via electrolyte 210. Since the cathodes 204 are centrally disposed, they are readily replaceable. Both cathode portions 204 are attached to each other with a collapsible mechanism 202. The inclusion of the collapsible mechanism 202 allows opening or closure of an air gap 212 between the cathodes. The collapsible mechanism 202 may include, but is not limited to, mechanical assemblies, memory metal structures, or the like. For example, the collapsible mechanism may comprise a cam system, an actuator based system, springs, latches, gears, pulleys, or any combination thereof, as will be apparent to those skilled in the mechanical and electromechanical arts

In another embodiment, the collapsible mechanism 202 may comprise shape memory alloy material which may be in mechanical cooperation with the cathode portions 204 and; upon selective activation, the shape memory alloy may be altered, i.e., the shape thereof changed, to allow for the collapse of the cathode 204. Note that although a plurality of shape memory alloys are depicted, only one shape memory alloy may be employed. The shape memory alloy may be, for example, wire, tube, plate, or other suitable structure formed of shape memory alloy material. These materials demonstrate the ability to return to a previously defined shape and/or size when subjected to an appropriate thermal procedure. These materials may include, for example, nickel-titanium alloys and copper-based alloys such as copper-zinc-aluminum and copper-aluminum-nickel.

Shape memory alloys are alloys which undergo a crystalline phase transition upon applied temperature and/or stress variations. In normal conditions, the transition from a shape memory alloy's high temperature state, austenite, to its low temperature state, martensite, occurs over a temperature range which varies with the composition of the alloy, itself, and the type of thermal-mechanical processing by which it was manufactured.

When stress is applied to a shape memory alloy member while in the austenite phase, and the member is cooled through the austenite to martensite transition temperature range, the austenite phase transforms to the martensite phase, the shape of the shape memory alloy member is altered due to the applied stress. Upon the application of heat, the shape memory alloy member returns to its original shape when it transitions from the martensite phase to the austenite phase.

In general, shape memory alloys can be categorized into two classes: one-way and two-way. Upon heating to a specific temperature range, one-way shape memory alloys recover a predefined shape, which is predefined with suitable heating steps. One-way shape memory alloys do not return to the original shape upon cooling. Two-way shape memory alloys, on the other hand, return to the preheated shape after cooling. Further detail regarding shape memory alloys is known, for example, is described in “Shape Memory Alloys” by Darel E. Hodgeskin, Ming H. Wu, and Robert J. Biermamm¹, which is incorporated by reference herein.
¹http://www.sma-inc.com/SMA.Paper.html

Accordingly, the material of the shape memory alloy should be selected so that unwanted shape memory alloy change does not take place. The internal temperature of the cell should not rise to level that will cause the shape memory alloy to undergo change. Alternatively, this internal temperature can be used as a mechanism to purposely induce shape change of the shape memory alloy. This may be useful, for example, as a safety device to prevent overheating of the cell.

Generally, to provide controlled collapse of the cathode portions 204, a heating system is employed (not shown). A heating system may include one or more electric heaters proximate to the shape memory alloy. Alternatively, electric current may be passed directly through the shape memory alloy to heat it to the desired temperature. The energy may be derived directly from the battery or cell itself, or alternatively from an external or separately integrated battery. For example, a smaller rechargeable battery dedicated to the shape memory alloy system or other collapsible mechanism. Such dedicated battery(s) may then be recharged from the main cell, i.e., during discharging thereof as described herein.

Note that to prevent electrical shorting, one or both ends of the shape memory alloy should be secured to an insulator upon the appropriate electrode.

With a one-way shape memory alloy change, when the alloy is heated to change shape (i.e., as shown generally from FIG. 2A to the position in FIG. 2B), the shape memory alloy generally will not return back to the original configuration (i.e., the configuration of FIG. 2A, and the configuration of the shape memory alloy wherein upon heating it expands to the configuration in FIG. 2B). Therefore, an external force must be provided to return the cathode 204 to its non-use or charging position, which would accordingly return the shape memory alloy to the position before heating. This force may be provided manually, with springs, with other shape memory alloy actuators, or with a variety of other mechanical apparatus. Further, this may be an automated system, whereby an electronic controller determines the need to revert to the original position and subsequently provides a signal for the mechanical force.

With the two-way shape memory alloy, the heat that is utilized to transform the shape of the shape memory alloy must be maintained in order to maintain the shape. When the heat is removed, the shape memory alloy reverts back to the shape of the unheated shape memory alloy.

Note that with either the one-way or two-way shape memory alloys, the preheated and heated shapes may be associated with different positions of the configurations shown in FIGS. 2A and 2B. For instance, and in one configuration, the preheated shape of the shape memory alloy may be as depicted in FIG. 2A, and the heated shape depicted in FIG. 2B. Alternatively, the preheated shape may be as depicted in FIG. 2B, and the heated shape may be as depicted in FIG. 2A. In this embodiment, for instance with a two-way shape memory alloy, the power to provide the heat to the shape memory alloy to maintain in the non-use or charging position may be derived from the cell itself.

Referring particularly to FIG. 2A, the cathode is shown in charging mode. The collapsed cathodes reduce or block the airflow along the cathode, thus decreasing CO₂ poisoning of the cathode during recharging. Further, the collapsed cathodes increase the space inside the cell structure, thus allowing oxygen bubbles to escape. Additionally, the position achieved by the collapsible mechanism can be used to disconnect the cathode from the rest of the cell, thus preventing unnecessary degradation of the cathode and self-discharge of the cell.

In rechargeable cells, it is oftentimes desirable to charge the anode while minimizing or eliminating involvement of the air cathode, thus there is a need to switch the electrical connection between the air cathode (for discharging operation) and the third electrode (for recharging operation). Metal-air technology offers the highest available energy density of any available primary battery system. For example, in a zinc-air cell, oxygen diffuses into the cell and is used as the cathode reactant. The air cathode catalytically promotes the reaction of oxygen with an aqueous alkaline electrolyte and is not consumed or changed during the discharge. The major disadvantage of this is the air cathode cannot be used effectively for recharging of the cell, as it may become partially consumed or changed, which would detrimentally affect cell performance and ultimately the useful lifetime of the cell. Thus, the addition of an extra electrode (that is, the third electrode) allows for a suitable zinc-air cell rechargeable cell. As shown in FIG. 2A, care is taken so that no current is passed through cathode during recharging.

FIG. 2B shows the cathode position in discharging mode. In this position, the cathodes 204 are pushed toward the anodes 208. This increases the air gap between the cathodes 204, thus providing sufficient air/oxygen required for reaction. Further, it decreases the electrolyte gap between each set of cathode 204 and anode 208, thus reducing the cell internal resistance.

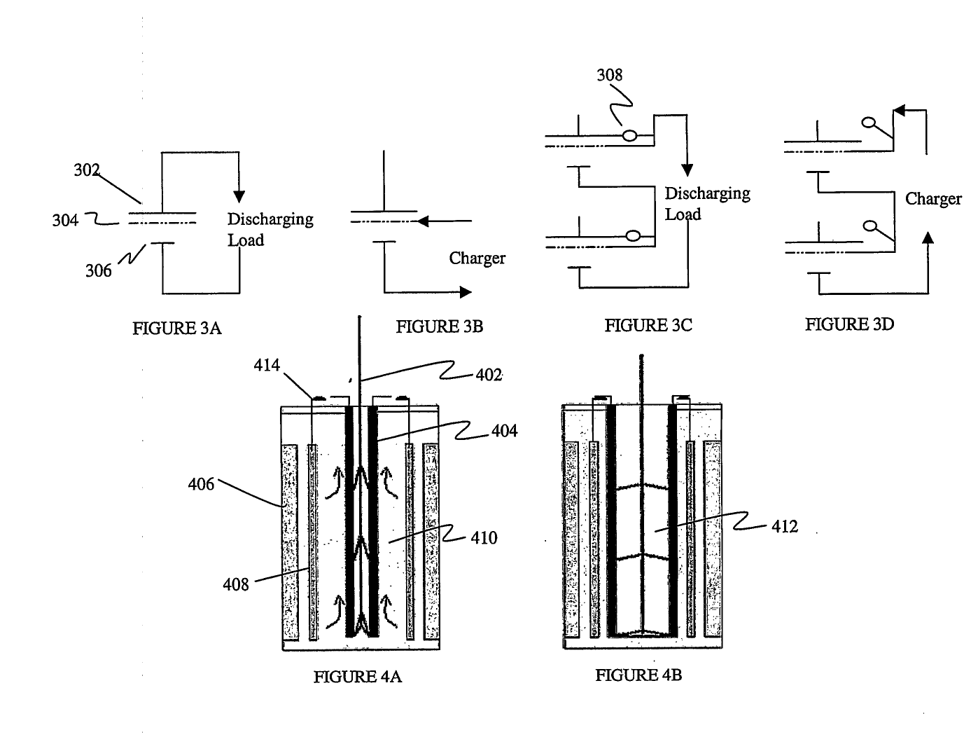

Referring now to FIGS. 3A-3D, discharging and recharging circuit diagrams for various configurations of metal air cells are shown. FIG. 3A shows discharging of a single metal air cell having a cathode 302, a third electrode 304 and an anode 306. FIG. 3B shows recharging of a single metal air cell. Note that although not shown, the circuit arrangements of FIGS. 3A and 3B typically require a switch or substitute therefor associated with the third electrode(s) and a switch or substitute therefor associated with the cathode(s).

FIG. 3C shows discharging of a cell system whereby the third electrode remains connected during discharging, and FIG. 3D shows recharging of a cell system cells in series, wherein the third electrode remains connected during discharging. During charging, the cathode is disconnected with switch/contact 308 from rest of the circuit. During discharging, the cathode is connected with switch/contact 308 with the rest of the circuit. Accordingly, when the switch is in the closed position the cathode remains connected to a third electrode and the circuit is configured for discharging operations. In this configuration, the switching circuit in the discharge path minimizes various detriments associated with multiple switches mechanisms. Such detriments include increased internal resistance due to the contact resistance of the switches, power loss and heat generation during discharging, and inefficiencies associated with multiple switch driving mechanism.

Note that, while not wishing to be bound by theory, it is possible that the combination of the air diffusion electrode and the anode, and the charging electrode (which is often formed of nickel) and the anode, form a synergetic combination, and may exhibit properties of both metal air electrochemical cells and nickel-zinc electrochemical cells.

When the switch is switched to the open position, the cathode is no longer connected to a third electrode of the adjacent cell and a cell circuit is configured for recharging operations. Therefore, no current passes through cathode during charging operations.

The switches may be any conventional switch capable of handling the desired current and/or voltage. Suitable switches include, but are not limited to, mechanical switches, semiconductor switches, or molecular (chemical) switches, or any of the switching schemes, disclosed in U.S. application Ser. No. 09/827,982 filed Apr. 6, 2001 entitled “Electrochemical Cell Recharging System,” by Aditi Vartak and Tsepin Tsai, and incorporated by reference herein.

The conventional cell or a cell structure with rigid cathode will need additional arrangement to incorporate this disconnection. However, with the collapsible cathode movement of the cathodes 204, the contact can readily be connected and disconnected without additional arrangements. Therefore, as shown in FIGS. 4A and 4B, in the charging position (FIG. 4A) the cathodes 404 are in the collapsed position and the contact 414 is open, thus disconnecting the contact between cathode and third electrode 408. In the discharging position (FIG. 4B) the contact is closed connecting cathode and third electrode together.

In further embodiments the system can incorporate other features, i.e. ionic isolating system as described in more detail in U.S. Ser. No. 10/145,278 filed on May 14, 2002 entitled “Metal Air Cell Incorporating Ionic Isolation Systems” by Sadeg Faris, and incorporated by reference herein. Further the cell may be configured in a wedge shape as detailed in U.S. Ser. No. 10/074,893 filed on Feb. 11, 2002 entitled “Metal Air Cell System” by George Tzong-Chyi Tzeng and Craig Cole.

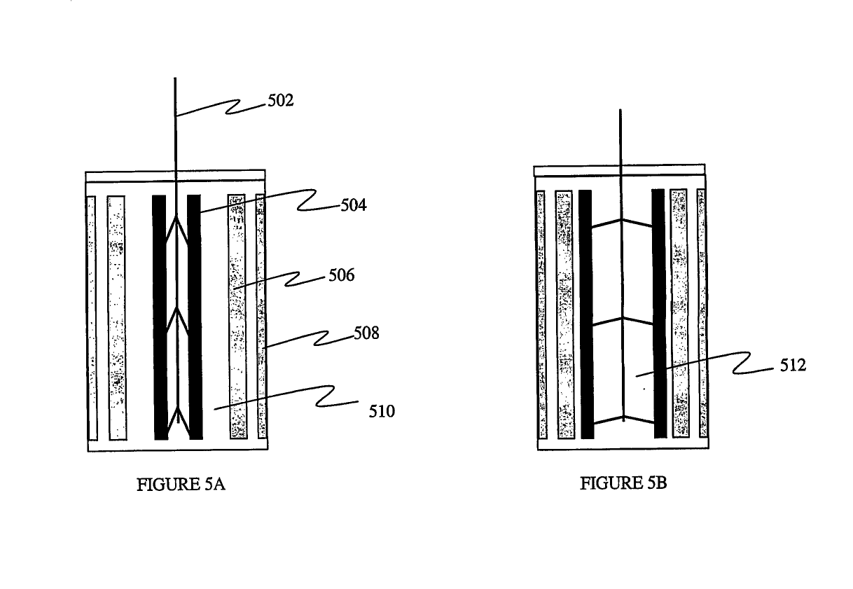

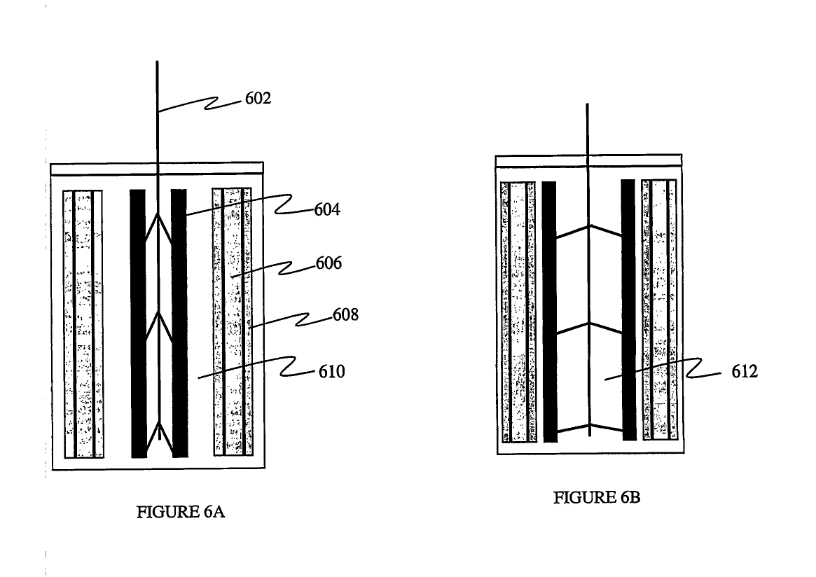

Note that the configuration (e.g., the relative positions) of the anode, cathode and third electrode may differ from those described thus far without departing from the scope of the invention. For example, in one embodiment as shown in FIGS. 5A and 5B, the anodes 506 are positioned between pairs of third electrode 508 and cathode 504. In the charging position (FIG. 5A) the cathode 504 is in the collapsed position. In the discharging position (FIG. 5B) the collapsible mechanism expands to bring cathode 504 closer to anode 506 and open the airway to the air cathode. In another embodiment as shown in FIGS. 6A and 6B, each anode 606 may include a pair of third electrodes, to expedite charging and maximize charging efficiency.

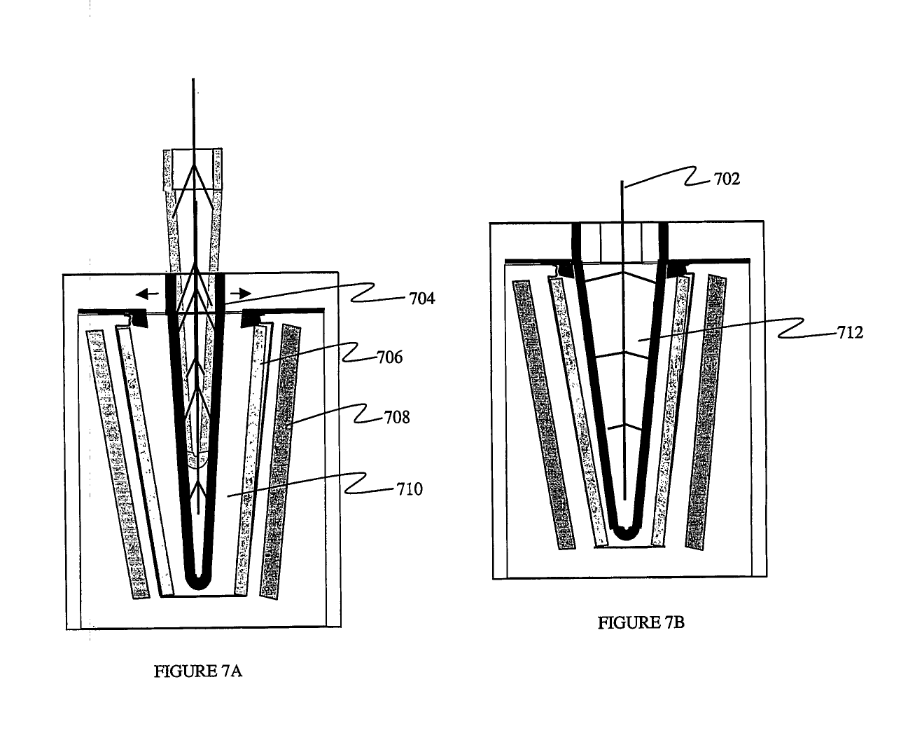

Further, the overall shape of the cell system is not limited to prismatic as shown thus far. For example, as shown in FIGS. 7A, 7B, 8A, 8B, 9A and 9B, the system utilizing the collapsible mechanism may be in a wedge configuration, e.g., as described in more detail in aforementioned U.S. Ser. No. 10/074,893 filed on Feb. 11, 2002 entitled “Metal Air Cell System”, which is incorporated by reference herein. In the embodiment of FIGS. 7A and 7B, the charging electrodes 708 are outside the anodes 706 relative the cathodes 704. Note the cathodes 704 and the collapsible mechanism 702 associated therewith are removable, and the third electrodes 708 remain in the anode assembly. When the anodes are reconditioned, for example, in a cell that is rechargeable, then whereby the anode portions are replaceable after a certain number of recharging cycles, the third electrodes may be reused.

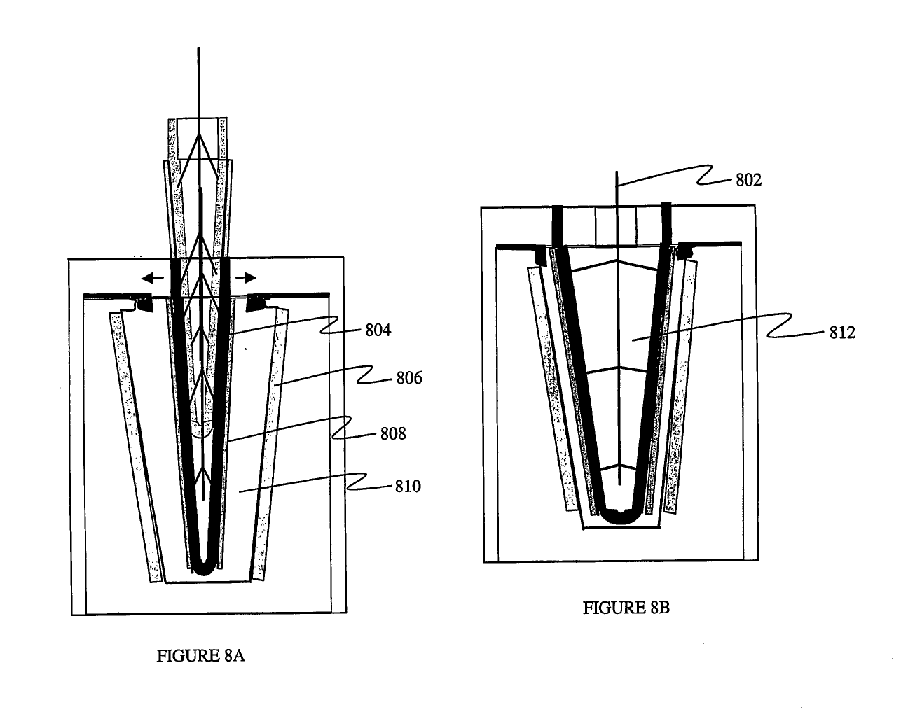

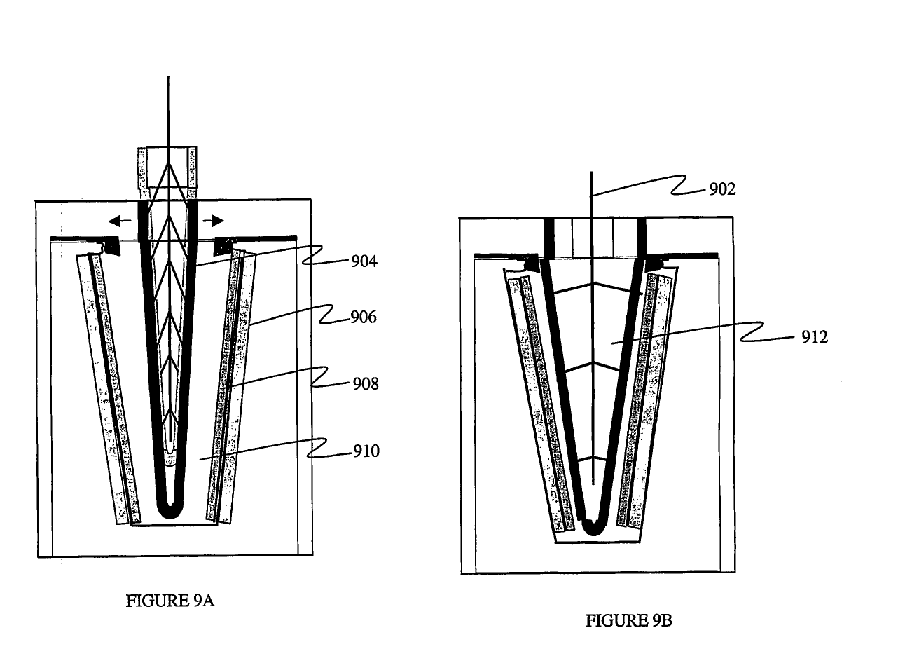

In the embodiment of FIGS. 8A and 8B, the charging electrodes 808 are proximate the cathodes 804, electrically separated with a separator. Note the cathodes 804, the charging electrodes 808 and the collapsible mechanism 802 associated therewith are removable. When the anodes are reconditioned, for example, in a cell that is rechargeable, then whereby the anode portions are replaceable after a certain number of recharging cycles, the third electrodes associated with the cathodes may be reused.

In the embodiment of FIGS. 9A and 9B, the charging electrodes 908 are between the anodes 906 and the cathodes 904. Note the cathodes 904 and the collapsible mechanism 902 associated therewith are removable, and the third electrodes 908 remain in the anode assembly. When the anodes are reconditioned, for example, in a cell that is rechargeable, then whereby the anode portions are replaceable after a certain number of recharging cycles, the third electrodes may be reused.

The anodes 204 generally comprises a metal constituent such as metal and/or metal oxides and a current collector. For a rechargeable cell, it is known in the art to utilize a formulation including a combination of a metal oxide and a metal constituent. Optionally an ionic conducting medium is provided within the anode portion. Further, in certain embodiments, the anode comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles. In certain embodiments, granule metal, particularly zinc alloy metal, is provided as the metal constituent. During conversion in the electrochemical process, the metal is generally converted to a metal oxide.

The anode current collector may be any electrically conductive material capable of providing electrical conductivity and optionally capable of providing support to the anode portion. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure. As described herein, certain embodiments utilize extensions of the current collector as power output terminals.

The electrolyte or ionic conducting medium generally comprises alkaline media to provide a path for hydroxyl to reach the metal and metal compounds. The ionically conducting medium may be in the form of a bath, wherein a liquid electrolyte solution is suitably contained. In certain embodiments, an ion conducting amount of electrolyte is provided in the anode portions. The electrolyte generally comprises ionic conducting materials such as KOH, NaOH, LIOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The optional binder of the anode primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The oxygen supplied to the cathode portions may be from any oxygen source, such as air; scrubbed air; pure or substantially oxygen, such as from a utility or system supply or from on site oxygen manufacture; any other processed air; or any combination comprising at least one of the foregoing oxygen sources.

The cathode portions may be conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations. The cathode may be a bi-functional, for example, which is capable of both operating during discharging and recharging. However, utilizing the systems described herein, the need for a bi-functional cathode is obviated, since the third electrode serves as the charging electrode.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in U.S. Pat. No. 6,368,751, entitled “Electrochemical Electrode For Fuel Cell”, to Wayne Yao and Tsepin Tsai, which is incorporated herein by reference in its entirety. Other air cathodes may instead be used, however, depending on the performance capabilities thereof, as will be obvious to those of skill in the art.

To electrically isolate the anode from the cathode, a separator is provided between the electrodes, as is known in the art. The separator may be any commercially available separator capable of electrically isolating the anode and the cathode, while allowing sufficient ionic transport between the anode and the cathode. The separator may be disposed in physical and ionic contact with at least a portion of at least one major surface of the anode, or all major surfaces of the anode, to form an anode assembly. In still further embodiments, the separator is disposed in physical and ionic contact with substantially the surface(s) of the cathode that will be proximate the anode

The physical and ionic contact between the separator and the anode may be accomplished by: direct application of the separator on one or more major surfaces of the anode; enveloping the anode with the separator; use of a frame or other structure for structural support of the anode, wherein the separator is attached to the anode within the frame or other structure; or the separator may be attached to a frame or other structure, wherein the anode is disposed within the frame or other structure.

Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator may also comprise additives and/or coatings such as acrylic compounds and the like to make them more wettable and permeable to the electrolyte.

In certain embodiments, the separator comprises a membrane having electrolyte, such as hydroxide conducting electrolytes, incorporated therein. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

In certain embodiments, electrolyte gel may be either applied directly on the surface of the evolution and/or reduction electrodes, or applied as a self supported membrane between the evolution and reduction electrodes. Alternatively, the gel may be supported by a substrate (e.g., a separator) and incorporated between the evolution and reduction electrodes.

The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The gelling agent for the electrolyte may be any suitable gelling agent in sufficient quantity to provide the desired consistency of the material. The gelling agent may be a crosslinked polyacrylic acid (PAA), such as the Carbopol® family of crosslinked polyacrylic acids (e.g., Carbopol® 675) available from BF Goodrich Company, Charlotte, N.C., Alcosorb® G1 commercially available from Allied Colloids Limited (West Yorkshire, GB), and potassium and sodium salts of polyacrylic acid; carboxymethyl cellulose (CMC), such as those available from Aldrich Chemical Co., Inc., Milwaukee, Wis.; hydroxypropylmethyl cellulose; gelatine; polyvinyl alcohol (PVA); poly(ethylene oxide) (PEO); polybutylvinyl alcohol (PBVA); combinations comprising at least one of the foregoing gelling agents; and the like. Generally, the gelling agent concentration is from about 0.1% to about 50% preferably about 2% to about 10%.

The optional substrate may be provided in forms including, but not limited to, woven, non-woven, porous (such as microporous or nanoporous), cellular, polymer sheets, and the like, which are capable of allowing sufficient ionic transport between the reduction and evolution electrodes. In certain embodiments, the substrate is flexible, to accommodate electrochemical expansion and contraction of the cell components, and chemically inert to the cell materials. Materials for the substrate include, but are not limited to, polyolefin (e.g., Gelgard® commercially available from Daramic Inc., Burlington, Mass.), polyvinyl alcohol (PVA), cellulose (e.g., nitrocellulose, cellulose acetate, and the like), polyamide (e.g., nylon),_cellophane, filter paper, and combinations comprising at least one of the foregoing materials. The substrate may also comprise additives and/or coatings such as acrylic compounds and the like to make them more wettable and permeable to the electrolyte.

In other embodiments of a hydroxide-conducting membrane as a separator, a molecular structure is provided that supports a hydroxide source, such as an aqueous electrolyte. Such membranes are desirable in that conductivity benefits of aqueous electrolytes may be achieved in a self supported solid state structure. In certain embodiments, the membrane may be fabricated from a composite of a polymeric material and an electrolyte. The molecular structure of the polymeric material supports the electrolyte. Cross-linking and/or polymeric strands serve to maintain the electrolyte.

In one example of a conductive separator, a polymeric material such as polyvinyl chloride (PVC) or poly(ethylene oxide) (PEO) is formed integrally with a hydroxide source as a thick film. In a first formulation, one mole of KOH and 0.1 mole of calcium chloride are dissolved in a mixed solution of 60 milliliters of water and 40 milliliters of tetrahydrogen furan (THF). Calcium chloride is provided as a hygroscopic agent. Thereafter, one mole of PEO is added to the mixture. In a second formulation, the same materials for the first formula are used, with the substitution of PVC for PEO. The solution is cast (or coated) as a thick film onto substrate, such as polyvinyl alcohol (PVA) type plastic material. Other substrate materials preferably having a surface tension higher than the film material may be used. As the mixed solvents evaporate from the applied coating, an ionically-conductive solid state membrane (i.e. thick film) is formed on the PVA substrate. By peeling the solid state membrane off the PVA substrate, a solid-state ionically-conductive membrane or film is formed. Using the above formulations, it is possible to form ionically-conductive films having a thickness in the range of about 0.2 to about 0.5 millimeters.

Other embodiments of conductive membranes suitable as a separator are described in greater detail in: U.S. patent application Ser. No. 09/259,068, entitled “Solid Gel: Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Tsepin Tsai, Muguo Chen and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001, all of which are incorporated by reference herein in their entireties. These membranes are generally formed of a polymeric material comprising a polymerization product of one or more monomers selected from the group of water-soluble ethylenically unsaturated amides and acids, and optionally a water-soluble or water swellable polymer, or a reinforcing agent such as PVA. Such membranes are not only desirable because of the high ionic conductivity due to the liquid electrolyte integral therein, but they also provide structural support and resistance to dendrite growth, thereby providing a suitable separator for recharging of metal air electrochemical cells.

In certain embodiments, the polymeric material used as separator comprises a polymerization product of one or more monomers selected from the group of water soluble ethylenically unsaturated amides and acids, and optionally a water soluble or water swellable polymer. The polymerized product may be formed on a support material or substrate. The support material or substrate may be, but not limited to, a woven or nonwoven fabric, such as a polyolefin, polyvinyl alcohol, cellulose, or a polyamide, such as nylon. Further, the polymerized product may be formed directly on the anode or cathode of the cell.

The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included.

The water soluble ethylenically unsaturated amide and acid monomers may include methylenebisacrylamide, acrylamide, methacrylic acid, acrylic acid, 1-vinyl-2-pyrrolidinone, N-isopropylacrylamide, fumaramide, fumaric acid, N,N-dimethylacrylamide, 3,3-dimethylacrylic acid, and the sodium salt of vinylsulfonic acid, other water soluble ethylenically unsaturated amide and acid monomers, or combinations comprising at least one of the foregoing monomers.

The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure.

Optionally, a crosslinking agent, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents.

A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled, and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution.

Polymerization is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof.

To control the thickness of the membrane, the coated fabric may be placed in suitable molds prior to polymerization. Alternatively, the fabric coated with the monomer solution may be placed between suitable films such as glass and polyethylene teraphthalate (PEI) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high. In still further embodiments of the separator, anion exchange membranes are employed. Some exemplary anion exchange membranes are based on organic polymers comprising a quaternary ammonium salt structure functionality; strong base polystyrene divinylbenzene cross-linked Type I anion exchangers; weak base polystyrene divinylbenzene cross-linked anion exchangers; strong base/weak base polystyrene divinylbenzene cross-linked Type II anion exchangers; strong base/weak base acrylic anion exchangers; strong base perfluoro aminated anion exchangers; naturally occurring anion exchangers such as certain clays; and combinations and blends comprising at least one of the foregoing materials.

As generally discussed above, the separator may be adhered to or disposed in ionic contact with one or more surfaces of the anode and/or the cathode. For example, a separator may be pressed upon an anode or a cathode.

Another example of a suitable anion exchange membrane is described in greater detail in U.S. Pat. No. 6,183,914 and incorporated by reference herein. The membrane includes an ammonium-based polymer comprising (a) an organic polymer having an alkyl quaternary ammonium salt structure; (b) a nitrogen-containing, heterocyclic ammonium salt; and (c) a source of hydroxide anion.

In yet another embodiment, mechanical strength of the resulting membrane may be increased by casting the composition on a support material or substrate, which is preferably a woven or nonwoven fabric, such as a polyolefin, polyester, polyvinyl alcohol, cellulose, or a polyamide, such as nylon.

The charging electrode 206 may comprise an electrically conducting structure, for example a mesh, porous plate, metal foam, strip, wire, plate, or other suitable structure. In certain embodiments, the charging electrode 206 is porous to allow ionic transfer. The charging electrode 206 may be formed of various electrically conductive materials including, but not limited to, copper, ferrous metals such as stainless steel, nickel, chromium, titanium, and the like, and combinations and alloys comprising at least one of the foregoing materials. Suitable charging electrodes include porous metal such as nickel foam metal.

While preferred embodiments have been shown and described, various modifications and substitutions may be made thereto without departing from the spirit and scope of the invention. Accordingly, it is to be understood that the present invention has been described by way of illustrations and not limitation.

1. A rechargeable metal air electrochemical cell comprising:
a pair of cathode portions attached to each other with a collapsible mechanism;
an anode portion disposed in ionic communication and electrical separation with each cathode portion;
ionic media to provide ionic communication between the anode portions and the cathode portions;
a pair of third charging electrodes in ionic communication with the anode portions.

2. The rechargeable metal air cell as in claim 1, wherein the collapsible mechanism allows contraction of the cathode portions to open space between the cathode portions and the anode portions to facilitate oxygen bubbling during charging.

3. The rechargeable metal air cell as in claim 1, wherein the collapsible mechanism allows contraction of the cathode portions to cut off air supply during charging or during idle periods.

4. The rechargeable metal air cell as in claim 1, wherein the collapsible mechanism allows expansion of the cathode portions to open more space for the air channel to supply air or oxygen during discharging.

5. The rechargeable metal air cell as in claim 1, wherein the cathode portions are removable, replaceable and/or capable of being reconditioned.

6. The rechargeable metal air cell as in claim 1, wherein the anode portions are removable and replaceable.

7. The rechargeable metal air cell as in claim 1, wherein the collapsible mechanism allows contraction of the cathode portions to allow the cathode portions to be disconnected from the anode portions during idle or during charging process.

8. The rechargeable metal air cell as in claim 1, wherein the collapsible mechanism comprises a mechanical assembly.

9. The rechargeable metal air cell as in claim 1, wherein the collapsible mechanism comprises an electromechanical assembly.

10. The rechargeable metal air cell as in claim 1, wherein the collapsible mechanism comprises a shape memory alloy system.
